(19) United States
(12) Patent Application Publication
(10) Pub. No.: US 2018/0376193 A1
(43) Pub. Date: Dec. 27, 2018

(54) FRAME TRANSMISSION

(71) Applicant: Hewlett-Packard Development Company, L.P., Houston, TX (US)

(72) Inventors: Matthew Sullivan, Cambridge (GB); Robert Severn, San Francisco, CA (US)

(73) Assignee: Hewlett-Packard Development Company, L.P., Houston, TX (US)

(21) Appl. No.: 16/064,350

(22) PCT Filed: Mar. 17, 2016
(86) PCT No.: PCT/US2016/022856

§ 371 Date: Jun. 20, 2018

(51) Int. Cl. H04N 21/4223; H04N 21/472; G06F 17/30

(52) U.S. Cl. CPC H04N 21/4223; H04N 21/647; G06F 17/30047; H04N 21/47202

(57) ABSTRACT

Examples associated with frame transmission are disclosed. One example includes periodically transmitting frames captured from a video feed by a mobile device to a remote server. These frames are periodically transmitted at a first interval. A triggering motion of the mobile device is detected. Frames captured from the video feed by the mobile device are then periodically transmitted to the remote server at a second interval. The second interval is faster than the first interval.

### BACKGROUND

Augmented reality is an emerging technology that allows information to be presented to users based on images present in users' surroundings. Various types of devices may incorporate augmented reality technologies that superimpose an “aura” on an image or video when a “trigger image” is detected. These auras may facilitate presenting useful information to the user, allow the user to participate in various activities (e.g., virtual games), and so forth.

### BRIEF DESCRIPTION OF THE DRAWINGS

The present application may be more fully appreciated in connection with the following detailed description taken in conjunction with the accompanying drawings.

FIG. 1 illustrates an example mobile device associated with frame transmission.

FIG. 2 illustrates a flowchart of example operations associated with frame transmission.

FIG. 3 illustrates another flowchart of example operations associated with frame transmission.

FIG. 4 illustrates another example mobile device associated with frame transmission.

FIG. 5 illustrates another example mobile device associated with frame transmission.

FIG. 6 illustrates another flowchart of example operations associated with frame transmission.

FIG. 7 illustrates an example computing device in which example systems, and methods, and equivalents, may operate.

### DETAILED DESCRIPTION

Systems, methods, and equivalents associated with frame transmission are described. To display an aura associated with an augmented reality service based on a trigger image, the trigger image must first be detected. In some examples, frames potentially containing the trigger image may be analyzed directly by a device that captures the frames and/or displays modified frames for viewing by a user. In other examples, frames may be transmitted to a remote server that performs this analysis. This may be desirable when the remote server is specialized for detecting trigger images and is capable of efficiently searching frames for trigger images.

However, transmitting frames from a mobile device to a remote server may be bandwidth intensive. Because some data plans may begin charging additional fees after a certain amount of data has been transmitted too and/or from a mobile device, it may be desirable to limit transmission of frames from the mobile device until the mobile device believes it is likely a scanning attempt is being made. Consequently, based on a gesture or motion detected by the mobile device, a transmission rate of frames from the mobile device to the remote server may be temporarily increased. This gesture may be, for example, a position and/or motion that indicates the mobile device is being held in a manner that points a camera in the mobile device at a potential trigger image.

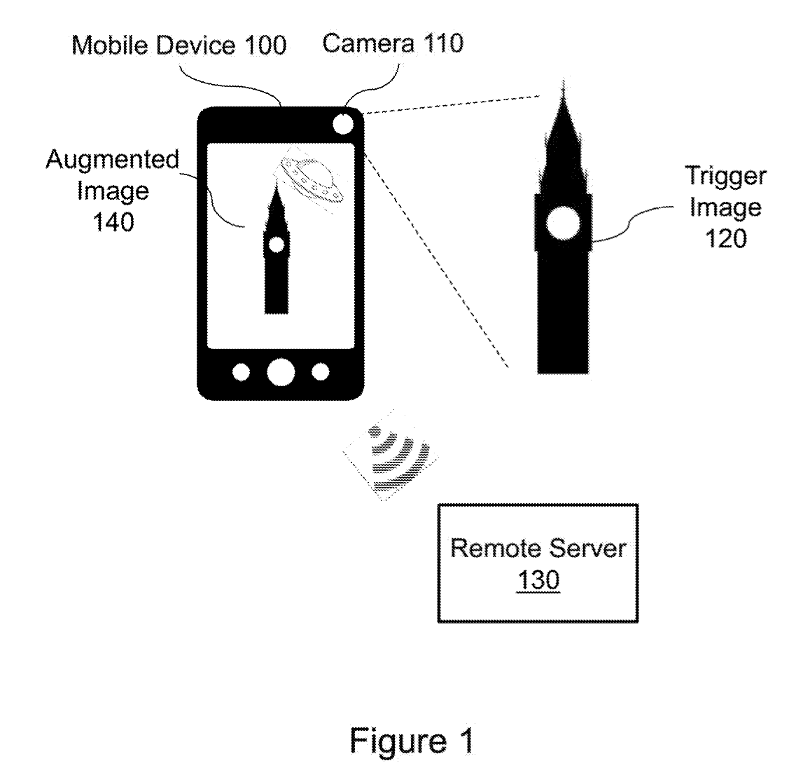

FIG. 1 illustrates an example mobile device associated with frame transmission. It should be appreciated that the items depicted in FIG. 1 are illustrative examples, and many different systems, and so forth, may operate in accordance with various examples.

FIG. 1 illustrates a mobile device 100 associated with frame transmission. Mobile device 100 may be, for example, a cellular phone, a tablet, or other device. Mobile device 100 may have an augmented reality module installed thereon. The augmented reality module may allow users of the mobile device to obtain virtual information about objects, pictures, and so forth that exist in reality. This virtual information may be stored within mobile device 100, on a remote server 130, and so forth, and displayed on a display of mobile device 100 under certain circumstances. In this example, the virtual information may take the form of an augmented image 140.

In the example illustrated in FIG. 1, trigger image 120 is Big Ben in London England. In various examples, camera 110 of mobile device 100 may need to be pointed at Big Ben itself. In other examples, a picture of Big Ben may suffice to serve as trigger image 120. Whether alternative images of Big Ben may serve as trigger image 120 may depend on the function of the augmented reality module installed on mobile device 100. By way of illustration, an advertising campaign may be indifferent as to whether Big Ben itself is scanned before displaying an augmented image 140 associated with the advertising campaign. On the other hand, a location aware game or activity module may seek to encourage users of the augmented reality module to visit Big Ben in person before acknowledging that trigger image 120 has been captured. In location aware examples, geographic data (e.g., GPS) and compass data may ensure the real Big Ben is scanned instead of an image.

Upon detecting capture of trigger image 120. The augmented reality module may cause an augmented image 140 to be shown on a display of mobile device 100. In various examples, the augmented image may add additional information or interactive elements to trigger image 120 prior to generate augmented image 140. In this example, the augmented reality module may be associated with an advertising campaign about a Patrick Swayze movie where Mr. Swayze fends off an alien invasion. Thus, the augmented reality module may transform trigger image 120 into an augmented image 140 that shows alien spaceships around Big Ben to promote the movie.

Thus, augmented image 140 may be presented to the user when a trigger image 120 is detected in a frame. As mentioned, in various examples, trigger image 120 may be a physical object, a picture, and so forth that may be captured via a visual detection technology embedded in mobile device 100. Here, camera 110 may be used to facilitate capture of trigger image 120. To detect whether trigger image 120 has actually been captured, the augmented reality module may periodically transmit video frames captured by camera 110 to remote server 130. Remote server 130 may be specialized for detecting trigger images 120 in frames of video captured by devices like mobile device 100.

Deciding which frames to transmit to remote server 130 may be based on whether mobile device 100 believes a scanning attempt is being made. This may reduce bandwidth consumption by the augmented reality module. As many data plans for mobile devices impose additional fees after a certain amount of cellular data has been transmitted, preventing inefficient use of this cellular data may be desirable. Consequently, if mobile device 100 does not believe a scanning attempt is being made, mobile device 100 may transmit frames received from camera 110 to remote server 130 at a first rate. In some examples, this first rate may be approximately one frame per second.

Upon detecting a scanning attempt, mobile device 100 may begin transmitting frames at a second, faster rate. In some examples, the faster rate may cause all frames captured by camera 110 to be transmitted to remote server 130 for analysis. This transmission rate may be, for example, thirty frames or more per second, depending on the technical specifications of mobile device 100 and/or camera 110. Increased transmission rate may also be used in other circumstances, such as when transmission of frames will not count against a data limit (e.g., over an uncapped wired or wireless connection).

The scanning attempt may be detected using motion data obtained by mobile device 100. The motion data may be obtained from, for example, a gyroscope within mobile device 100. Many different motions and/or gestures of mobile device 100 may indicate that a scanning attempt is being performed. These motions may depend on the expected size and/or locations of trigger images 120. For example, different motions may be anticipated if the trigger image is expected to be captured from a piece of paper resting on a flat surface, versus a physical outdoor landmark. One example motion may be a steady hold positioning of mobile device 100. A steady hold positioning motion may be detected when a user is holding mobile device 100 in such a way that camera 110 is steady and stable and pointed in a single direction for a predetermined period of time after being swiftly moved into the steady hold position. Other gestures may also indicate a scanning attempt. In some examples, location data and compass data may also be incorporated into determining whether a scanning attempt is being made. By way of illustration, location data and compass data may be used to determine if camera 110 is pointed towards a trigger image 120.

Once remote server 130 identifies that trigger image 120 is in a frame captured by camera 110, remote server 130 may transmit data to mobile device 100 that identifies the frame, the trigger image, the location of the trigger image within the frame, and so forth. In some examples, the data may provide the virtual information that will be used to generate augmented image 140. This may cause mobile device 100 to manipulate frames captured by camera 110. These frames may be presented to a user as augmented image 140 via a display of mobile device 100.

It is appreciated that, in the following description, numerous specific details are set forth to provide a thorough understanding of the examples. However, it is appreciated that the examples may be practiced without limitation to these specific details. In other instances, methods and structures may not be described in detail to avoid unnecessarily obscuring the description of the examples. Also, the examples may be used in combination with each other.

“Module”, as used herein, includes but is not limited to hardware, firmware, software stored on a computer-readable medium or in execution on a machine, and/or combinations of each to perform a function(s) or an action(s), and/or to cause a function or action from another module, method, and/or system. A module may include a software controlled microprocessor, a discrete module, an analog circuit, a digital circuit, a programmed module device, a memory device containing instructions, and so on. Modules may include gates, combinations of gates, or other circuit components. Where multiple logical modules are described, it may be possible to incorporate the multiple logical modules into one physical module. Similarly, where a single logical module is described, it may be possible to distribute that single logical module between multiple physical modules.

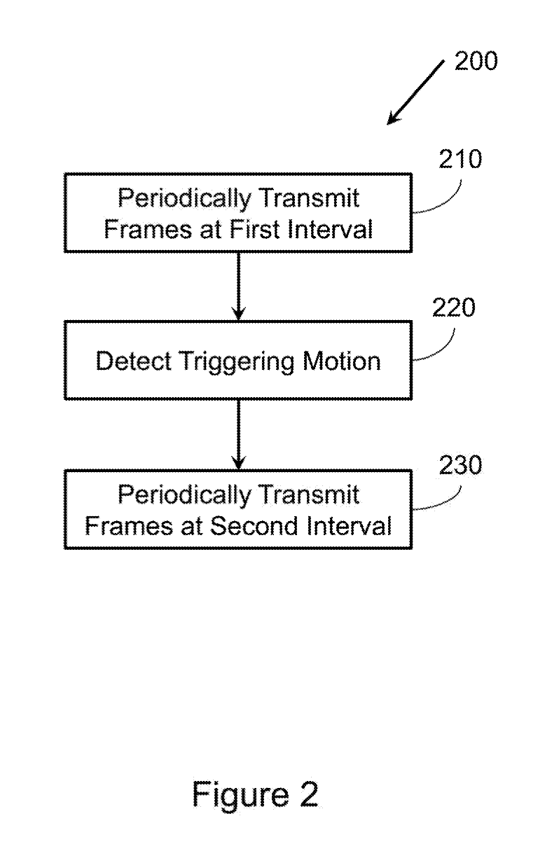

FIG. 2 illustrates an example method 200 associated with frame transmission. Method 200 may be embodied on a non-transitory processor-readable medium storing processor-executable instructions. The instructions, when executed by a processor, may cause the processor to perform method 200. In other examples, method 200 may exist within logic gates and/or RAM of an application specific integrated circuit (ASIC).

Method 200 includes periodically transmitting frames to a remote server at 210. The remote server may detect trigger images in frames and respond with information that facilitates augmenting the trigger image into an augmented image. The frames may be periodically transmitted at a first interval. The frames may be captured from a video feed by a mobile device. The video feed may be obtained from a camera embedded within the mobile device.

Method 200 also includes detecting a triggering motion of the mobile device at 220. The triggering motion may be detected using a gyroscope within the mobile device. The triggering motion may indicate that a user is attempting to capture a trigger image by holding the mobile device in a specific manner. By way of illustration, the triggering motion may be a steady hold positioning motion. Specifically, the steady hold positioning may be a positioning, by a user, of the mobile device so that it is held substantially still so that capture of the trigger image is possible.

Method 200 also includes periodically transmitting frames to the remote server at 230. At action 230, the frames may be transmitted at a second interval. The second interval may be faster than the first interval. Thus, in response to detecting the triggering motion, transmission of frames from the video feed may occur at an increased rate. Increasing the transmission rate may facilitate responsive detection of a trigger image within a frame of a video feed, while limiting bandwidth consumption caused by transmitting frames of the video feed to the remote server.

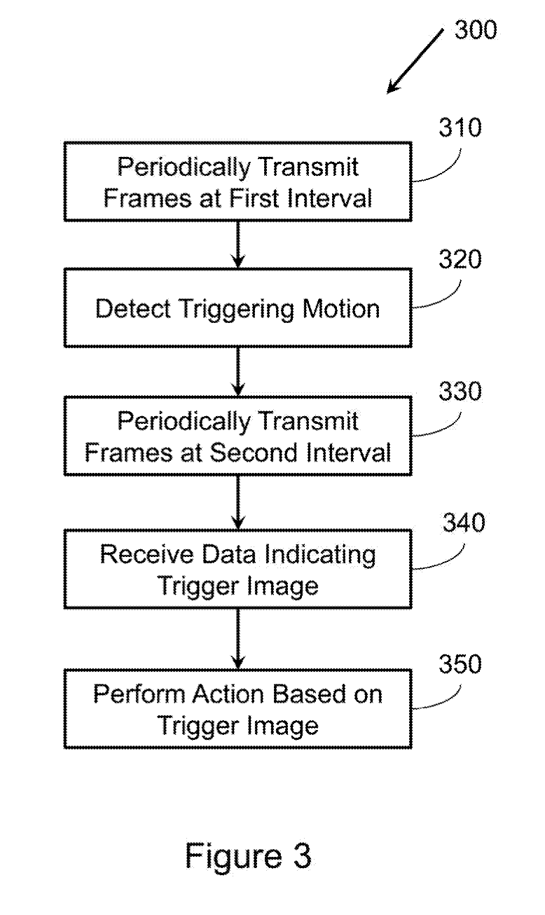

FIG. 3 illustrates a method 300 associated with frame transmission. Method 300 includes several actions similar to those described above with reference to method 200 (FIG. 2). For example, method 300 includes periodically transmitting frames captured by a mobile device to a remote server at a first interval at 310, detecting a triggering motion at 220, and periodically transmitting frames at a second interval at 330.

Method 300 also includes receiving data from the remote server at 340. The data may indicate presence of a trigger image within a frame of the video feed. The data may also indicate additional information that may facilitate manipulating the trigger image into an augmented image and providing the augmented image to the user. For example, the data may also indicate the location of the trigger image within the frame, which trigger image has been detected, how to manipulate the trigger image into the augmented image, and so forth.

Method 300 also includes performing an action at 350. The action may be performed based on the presence of the trigger image in the frame of the video feed. In various examples, the action may include manipulating one or more frames of the video feed and displaying the manipulated frames on a display of the mobile device.

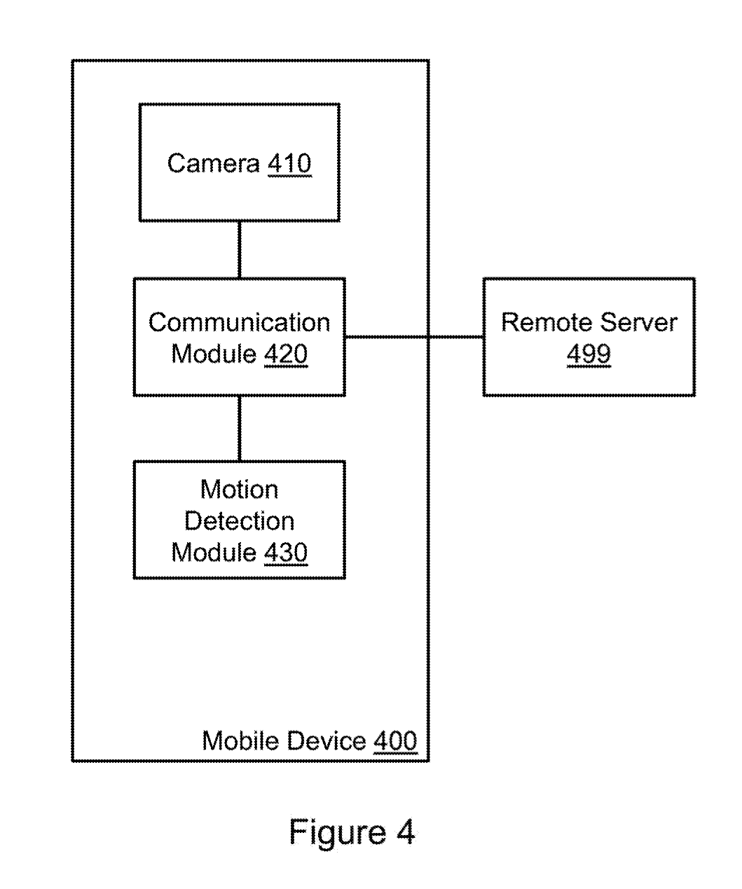

FIG. 4 illustrates a mobile device 400 associated with frame transmission. Mobile device 400 may be, for example, a cellphone, a tablet, and so forth. Mobile device 400 includes a camera 410. Camera 410 may capture frames of a video feed.

Mobile device 400 also includes a communication module 420. Communication module 420 may transmit frames of the video feed to a remote server 499. In some examples, communication module 420 may also receive data from remote server 499. The data may identify a frame of the video feed containing a trigger image. Mobile device 400 may use the data to display augmented information related to the trigger image to a user of mobile device 400

Mobile device 400 also includes a motion detection module 430. Motion detection module 430 may control a rate at which communication module 420 transmits the frames of the video feed to remote server 499. In some examples, the rate may be controlled when the communication module detects a scanning attempt. This detection may be performed based on a motion of the mobile device. By way of illustration, when motion detection module 430 detects a scanning attempt, motion detection module 430 may increase the rate at which communication module 420 transmits frames of the video feed to remote server 499.

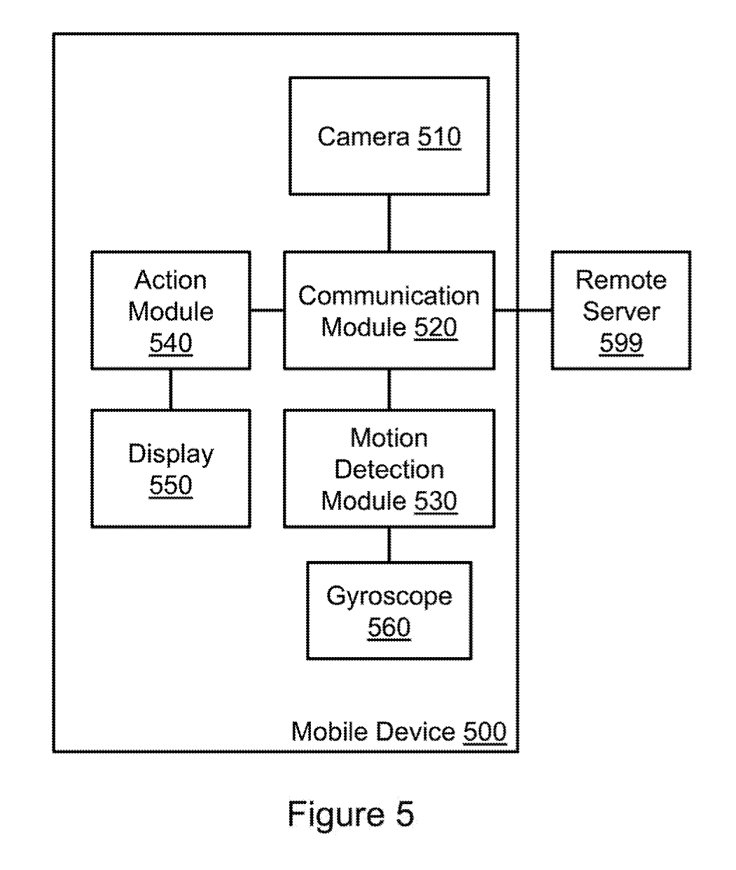

FIG. 5 illustrates a mobile device 500 associated with frame transmission. Mobile device 500 illustrates several items similar to those described above with reference to system 400 (FIG. 4). For example, mobile device 500 includes a camera 510, a communication module 520 to transmit frames of a video feed to a remote server 599, and a motion detection module 530.

Mobile device 500 also includes an action module 540. In examples where communication module 520 receives data identifying frames having trigger images, action module 540 may perform an action based on the trigger image. By way of illustration, the action may include modifying the frame of the video feed containing the trigger image and showing the modified frame via a display 550. In some examples, multiple frames of the video feed may be modified and displayed, effectively causing an augmented image to appear in relation to the trigger image in the video feed. This augmented image may, for example, add additional information to the video feed in relation to the trigger image, replace the trigger image, manipulate the trigger image, cause an animation to occur in relation to the trigger image, and so forth.

Mobile device 500 also includes a gyroscope 560. In various examples motion detection module 530 may detect the scanning attempt using the gyroscope. Thus, data received from gyroscope 560 may allow motion detection module to detect, for example, acceleration, orientation, and so forth of mobile device 500. Certain combinations of these motions and/or positionings of mobile device 500 may be used to estimate when a scanning attempt is being made by a user so that the frame transmission rate can be controlled.

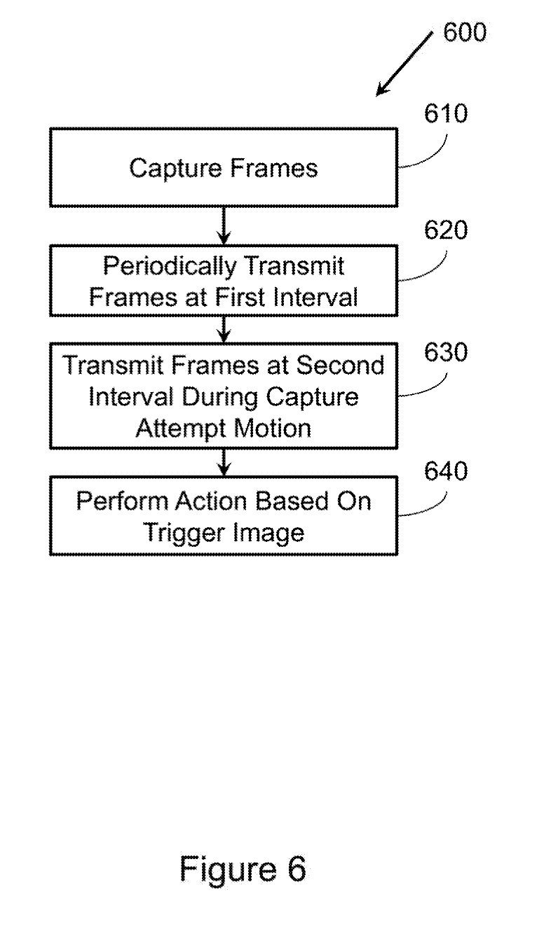

FIG. 6 illustrates a method 600 associated with frame transmission. Method 600 includes capturing a set of frames from a video feed at 610. The video feed may be received from a capture device associated with a mobile device in which the processor resides. The capture device may be, for example, a camera embedded in or attached to the mobile device.

Method 600 also includes periodically transmitting members of the set of frames to a remote server at a first interval at 620. In various examples, the members of the set of frames may be transmitted to the remote server via a wireless connection. The wireless connection may include, for example, a cellular connection, a WIFI connection, and so forth.

Method 600 also includes periodically transmitting members of the set of frames to the remote server at a second interval at 630. This action at 630 may be performed during a duration of a capture attempt motion. The capture attempt motion may be detected via a gyroscope within the mobile device. In some examples, the second transmission interval may be faster than the first transmission interval used at action 620. Manipulating the transmission interval may facilitate limiting data usage of the mobile device, while ensuring responsive detection of rigger images.

Method 600 also includes performing an action at 640. The action may be performed based on data received from the remote server identifying a trigger image in a member of the set of frames. The action may involve displaying one or more frames from the video feed on a display of the mobile device. These frames may be modified based on, for example, the trigger image, an aura image with which the trigger image is associated, and so forth.

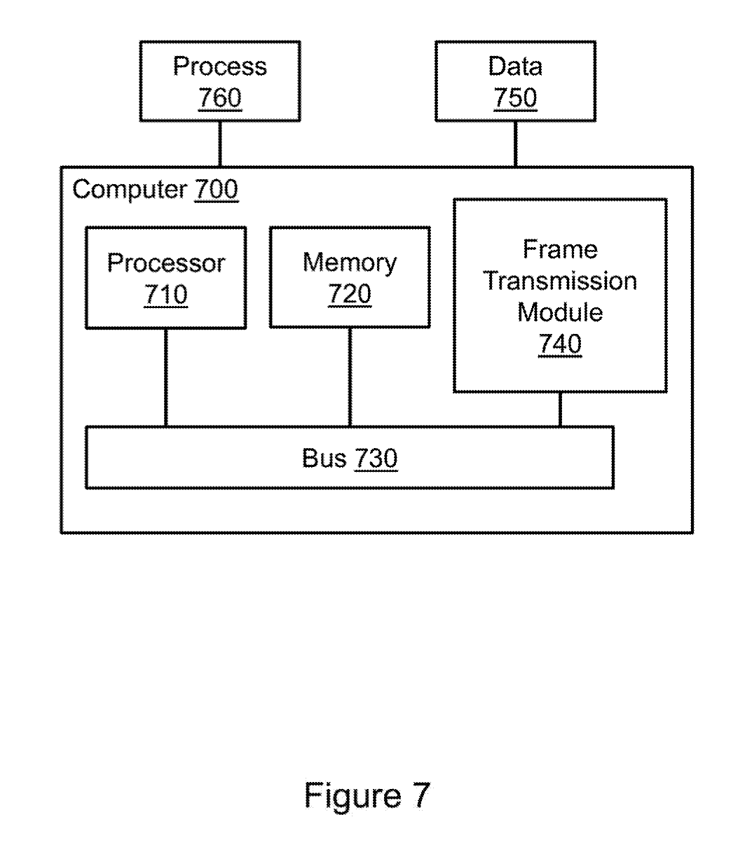

FIG. 7 illustrates an example computing device in which example systems and methods, and equivalents, may operate. The example computing device may be a computer 700 that includes a processor 710 and a memory 720 connected by a bus 730. Computer 700 includes a frame transmission module 740. Frame transmission module 740 may perform, alone or in combination, various functions described above with reference to the example systems, methods, apparatuses, and so forth. In different examples, frame transmission module 740 may be implemented as a non-transitory computer-readable medium storing processor-executable instructions, in hardware, software, firmware, an application specific integrated circuit, and/or combinations thereof.

The instructions may also be presented to computer 700 as data 750 and/or process 760 that are temporarily stored in memory 720 and then executed by processor 710. The processor 710 may be a variety of processors including dual microprocessor and other multi-processor architectures. Memory 720 may include non-volatile memory (e.g., read only memory) and/or volatile memory (e.g., random access memory). Memory 720 may also be, for example, a magnetic disk drive, a solid state disk drive, a floppy disk drive, a tape drive, a flash memory card, an optical disk, and so on. Thus, memory 720 may store process 760 and/or data 750. Computer 700 may also be associated with other devices including other computers, devices, peripherals, and so forth in numerous configurations (not shown).

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

What is claimed is:

1. A method, comprising:
periodically transmitting to a remote server at a first interval, frames captured from a video feed by a mobile device;
detecting a triggering motion of the mobile device; and
periodically transmitting to the remote server at a second interval, frames captured from the video feed by the mobile device, where the second interval is faster than the first interval.

2. The method of claim 1, comprising:
receiving data from the remote server indicating presence of a trigger image within a frame of the video feed.

3. The method of claim 2, comprising:
performing an action based on the presence of the trigger image in the frame of the video feed.

4. The method of claim 3, where the action includes manipulating one or more frames of the video feed and displaying the manipulated frames on a display of the mobile device.

5. The method of claim 1, where the triggering motion is detected using a gyroscope within the mobile device.

6. The method of claim 1, where the triggering motion is a steady hold positioning motion.

7. A mobile device, comprising:
a camera to capture frames of a video feed;
a communication module to transmit frames of the video feed to a remote server; and
a motion detection module to control a rate at which the communication module transmits the frames of the video feed to the remote server upon detecting a scanning attempt based on a motion of the mobile device.

8. The mobile device of claim 7, where the communication module receives data from the remote server identifying a frame of the video feed containing a trigger image.

9. The mobile device of claim 8, comprising an action module to perform an action based on the trigger image.

10. The mobile device of claim 9, comprising a display, and where the action comprises modifying the frame of the video feed containing the trigger image and showing the modified frame via the display.

11. The mobile device of claim 7, comprising a gyroscope, and where the motion detection module detects the scanning attempt using the gyroscope.

12. A non-transitory computer-readable medium storing processor-executable instructions that when executed by a processor cause the processor to:
capture a set of frames from a video feed received from a capture device associated with a mobile device in which the processor resides;
periodically transmit members of the set of frames to a remote server at a first interval;
during the duration of a capture attempt motion, periodically transmit members of the set of frames to the remote server at a second interval, where the second interval is faster than the first interval;
perform an action based on data received from the remote server identifying a trigger image in a member of the set of frames.

13. The non-transitory computer-readable medium of claim 12, where the members of the set of frames are transmitted to the remote server via a wireless connection.

14. The non-transitory computer-readable medium of claim 12, where the capture attempt motion is detected via a gyroscope in the mobile device.

15. The non-transitory computer-readable medium of claim 12, where the action involves displaying, on a display of the mobile device, one or more frames from the video feed that have been modified based on one or more of the trigger image and an aura image with which the trigger image is associated.
